(19) United States
(12) Patent Application Publication
(10) Pub. No.: US 2022/0164831 A1
(43) Pub. Date: May 26, 2022

(54) ADVERTISING METHOD FOR A SMARTPHONE OR A TABLET

(71) Applicant: Center Mobile Co., Ltd., Osaka (JP)

(72) Inventor: Tatsuya Nakagoshi, Osaka (JP)

(21) Appl. No.: 17/471,522

(22) Filed: Sep. 10, 2021

(30) Foreign Application Priority Data
Nov. 20, 2020 (JP) 2020-193110

(51) Int. Cl. G06Q 30/02

(52) U.S. Cl. CPC G06Q 30/0267; G06Q 30/0277

(57) ABSTRACT

The present application provides an effective advertising method for sponsors such as companies, using a server and a router. The server includes a communication unit that communicates with a terminal, a memory unit that stores data, an analyzing unit that analyzes the data, an advertising unit that distributes an advertisement to a terminal, and a memory unit stores a phone number and a private IP address of the terminal. The router has an IP address conversion process that converts a private IP address into a global IP address by NAT, the server has a domain conversion process that converts a global IP address into a domain name, the analyzing unit analyzes the domain name of the access destination corresponding to the phone number of the terminal stored in the memory unit, and the advertising unit distributes an advertisement to the terminal based on the analysis of the analyzing unit.

### TECHNICAL FIELD

This invention relates to an advertising system, advertising program, and advertising method for a terminal such as a smartphone and a tablet.

### BACKGROUND ART

Conventionally, the phone charge for a mobile phone such as a smartphone consists of a basic fee, a data service fee, and a call charge.

Since this fee has no upper limit, which may result in expensive phone charge, a user often chooses a flat rate plan.

However, this flat rate plan still has a problem because the transmission becomes slow when exceeding the upper data limit.

When choosing the flat rate plan with a higher upper data limit, the user needs to pay more expensive monthly fee.

Patent document 1 displays the technology that a part of the download purchase fee is paid from the advertising fee by reimbursing a part of the communication fee of the user, in exchange for showing advertisements instead of the conventional screen display during, before, or after the download when downloading music, videos, and games using a mobile phone or handy terminal.

### PRIOR ART DOCUMENT

### Patent Document

[Patent Document 1]

Japanese Unexamined Patent Application Publication No. 2009-211669

### Outline of the Invention

### Technical Problem that this Invention is to Solve

The invention relates to patent document 1, however, only reduces the actual downloading fee by showing advertisements when downloading a video or a game but does not reduce the user's monthly mobile phone fee.

In addition, many advertisements have nothing to do with the user, therefore, the companies providing the advertisements may not have much benefit.

It is difficult to get a user to be interested in the advertisements if these are shown regardless of the user's time schedule (push-type advertisements).

An advertisement that is difficult to attract a user may even give negative images to the user.

On the other hand, a company wants to distribute advertisements efficiently.

Today, online advertisements are selected according to interests of a user by analyzing the user's internet search histories.

With a smartphone or a tablet, a user does not use an internet browser but directly starts an application, therefore, it is difficult to accumulate accurate data to provide efficient advertisements.

The purpose of this invention is to provide an advertising method to reduce communication fee for a mobile phone, such as a smartphone or a tablet.

Another purpose of this invention is to provide an efficient advertising method for a sponsor such as a company.

### Solution to Problem

The advertising method relates to the first aspect of this invention is that it has a server and a router, and it is the advertising method to distribute an advertisement to a terminal including a smartphone and a tablet,
the server equipped with,
a communication unit to communicate with the terminal,
a memory unit to store data,
an analysis unit to analyze the data,
an advertising unit to distribute an advertisement to the terminal, and
the memory unit stores a phone number and a private IP address of the terminal, the router includes an IP address conversion process to convert a private IP address into a global IP address by NAT,
the server includes a domain conversion process to convert a global IP address into a domain name,
the analysis unit analyzes the domain name of the access destination corresponding to the phone number of the terminal stored in the memory unit, and,
the advertising unit distributes an advertisement to the terminal based on the analysis by the analyzing unit.

With such a method, the phone number of the terminal such as a smartphone, and the domain and the access destination accessed by the terminal may be linked and the advertisement that is closely fit to the user's needs may be provided to the terminal.

The server is not limited to only one but may exist several.

The communication passage from the phone number to the accessed domain may be acknowledged as point A to point B in a plain diagram.

The advertising method that relates to the second aspect of this invention is that it is the advertising method that relates to the first aspect,
the analyzing unit analyzes the communication information including the access destination of the terminal by data mapping the information of the terminal and the DNS information stored in the server.

“Data mapping” is a task or a process to associate items and elements of the different system that point to the same thing in the field such as data processing.

The data mapping enables the process to automatically reflect the change made on a certain item of a system to the corresponding item on the other system.

Such an advertising method provides the advertisement that is more fit to the terminal user's needs by linking the user's information such as the phone number of the terminal and the accessed domain.

The advertising method that relates to the third aspect of this invention is that it is the advertisement method that relates to the first and the second aspects of this invention, and the advertising unit distributes an advertisement to the terminal based on the keywords searched by the terminal.

By linking the information of the terminal and searched keywords, the information of the terminal and searched keywords are associated (for example: the terminal user's address), and the advertisement that is more fit to the terminal user's needs may be provided.

The advertising method that relates to the fourth aspect of this invention is that it is the advertising method that relates to the first, second, or third aspect of this invention, and that distributes the advertisement to the terminal by the advertising unit based on the location information of the terminal.

The location information may be found by GPS, for instance, and the information of the vicinity of the terminal may be provided based on the location information.

The advertising method that relates to the fifth aspect of this invention is that it is the advertising method that relates to the fourth aspect of this invention, the memory unit stores personal information including age, address, or gender of the user, and the advertising unit distributes the advertisement to the terminal based on the personal information.

For example, it may provide information around the user's address or the information suitable for the user's age and gender as an advertisement.

### BRIEF EXPLANATION OF THE DRAWING

FIG. 1 Conceptual scheme of an embodiment example of this invention of advertising system

FIG. 2 Conceptual scheme of advertising system of above embodiment

FIG. 3 Conceptual scheme of advertising system of above embodiment

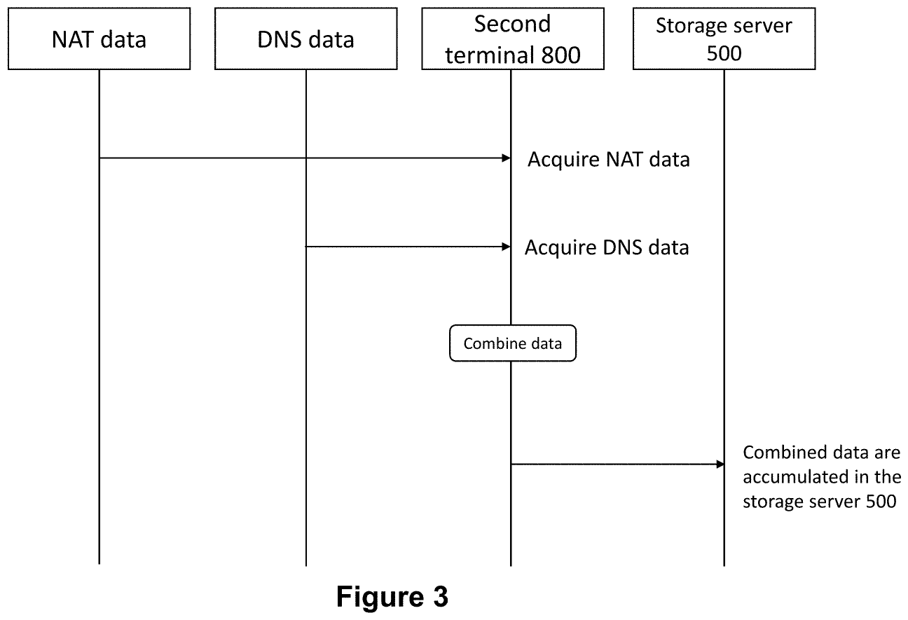

FIG. 4 Flow chart of the advertisement system of above embodiment

### DESCRIPTION OF EMBODIMENTS

The explanation of embodiments of this invention is provided referring to the drawings as followings.

NAT (Network address translation) is the technology that converts an IP address.

Generally, NAT is said to be the technology to convert a private IP address into a global IP address.

An internet is a network built using a global IP address. For example, since a company network is a network built using a private IP address, it needs to be converted (NAT) into a global IP address when a client PC in the company LAN network accesses the internet.

For example, a private IP address is a certain address assigned to a device such as a PC or a printer at home or workplace and used mainly at home between a home router and the house side.

On the other hand, DNS (Domain Name System) is the system developed to manage and operate a domain name on the internet.

DNS converts a domain name into an IP address to access the internet.

Specifically, for example, when a user types “karasuma. kyoto” on the web browser, the DNS server is asked to search the server for “karasuma. kyoto”.

Then, the DNS server that knows the IP address of “karasuma. kyoto” converts the domain name into the IP address and answers “aaa. bbb. s. ddd”

The user receives the IP address and accesses the web server that manages the “karasuma. kyoto” and displays the homepage.

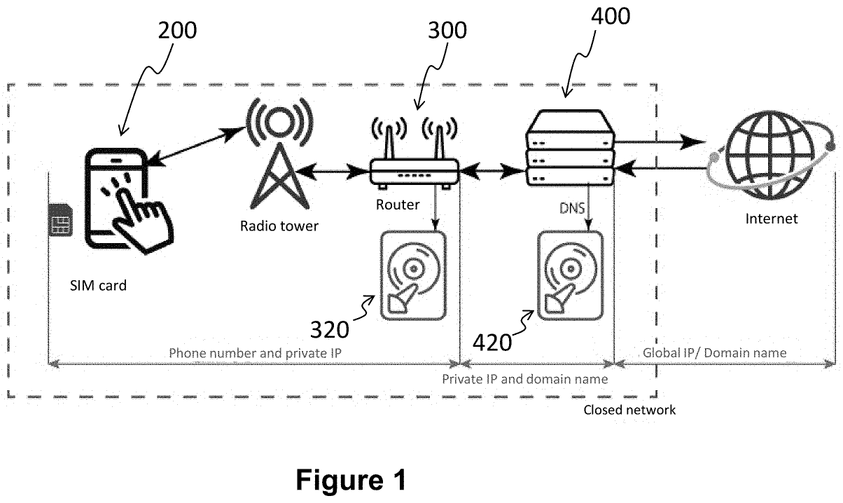

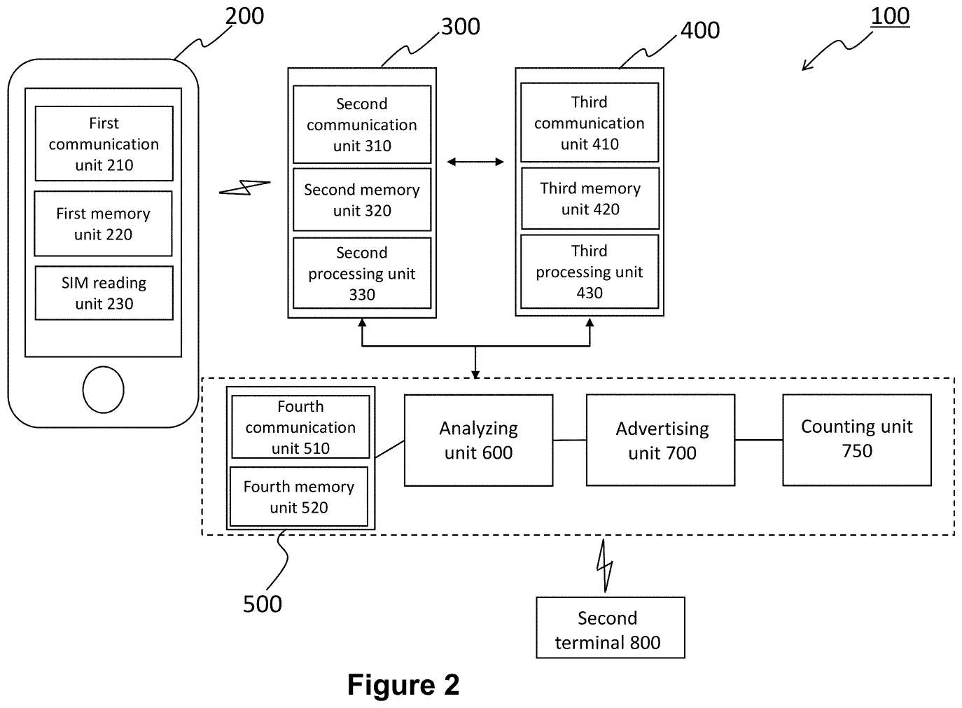

As shown in FIG. 1 and FIG. 2, the advertising system 100 related to this invention includes,
the first terminal 200 that reads SIM (Subscriber Identity Module) data,
the router 300 that is transmittable to the first terminal 200,
the DNS server 400 that is transmittable with the router 300,
the storage server 500 that is a server to store NAT data and DNA data,
the analyzing unit 600 to analyze NAT data and DNA data stored in the storage server 500,
the advertising unit 700 to display an advertisement to the first terminal 200 based on the data analyzed by the analyzing unit 600, and
the second terminal 800 to manage the DNS server 400, the storage server 500, the analyzing unit 600, and advertising unit 700.

In this embodiment, the router 300, the DNS server 400, and the storage server 500 are separately built, but they may either be in one device (such as a server) or several separate devices.

The second terminal 200 may be inserted a SIM card or read SIM data.

SIM is the identification module of the subscriber. For example, a SIM card is given a unique number called IMSI (International Mobile Subscriber Identity) and communication is enabled by connecting this number and the phone number.

By inserting and pulling out the SIM card, a phone number may be used on the other communication device or multiple phone numbers may be used on one communication device by using several different SIM cards. The phone number may be switched by reading SIM data.

### (The First Terminal 200)

The first terminal 200 includes,
the first communication unit 210 that communicates with the router 300,
the first memory unit 220 that stores SIM data, and
the SIM reading unit 230 that reads SIM card or SIM data.

The first communication unit 210 communicates with the router 300 and sends SIM data to the router 300.

The first memory unit 220 stores SIM data such as phone numbers.

The SIM reading unit 230 reads SIM data or SIM card information.

The SIM reading unit 230 reads SIM card either by physically inserting SIM card to the first terminal 200 or by holding the card over the first terminal 200.

### (Router 300)

The router 300 includes,
the second communication unit 310 commutable with the first terminal 200 and the DNS server 400,
the second memory unit 320 that stores the data such as the phone number and private IP address assigned to the SIM, and
the second processing unit 330 that coverts a private IP address into a global IP address.

The second communication unit 310 communicates with the first communication unit 210 of the first terminal 200, and
the router 300 acquires the phone number of the SIM data and the private IP address that is linked (associated) to the phone number.

In short, the router 300 links the private IP address (local IP address) and the phone number of the SIM, and communication is done by the DNS server 400 and the second communication unit 310.

The second communication unit 310 communicates with the DNS server 400, and the DNS server 400 acquires the private IP address of the first terminal 200.

The router 300 stores the private IP address of the SIM that is assigned by the second memory unit 320.

In short, the second memory unit 320 stores the phone number that is the SIM data of the first terminal 200 and the private IP address linked to the phone number.

Therefore, the second terminal 800 user receives the phone number of the SIM and the private IP address of the first terminal 200 from the second memory unit 320 of the router 300.

The router 300 converts a private IP address into a global IP address by the second processing unit 330 or conducts NAT, which is the reverse conversion.

The router 300 may provide the private IP address corresponding to the phone number assigned to the SIM of the first terminal 200 by the second processing unit 330.

From the above, the second terminal 800 user may link (associate) the first terminal 200 user and the private IP address from the private IP address and the owner's information registered. The router 300 may also act as a server.

### (DNS Server 400)

The DNS server 400 includes the third communication unit 410 that communicates with the router 300 and the interne,
the third communication unit 420 that stores the data such as log data, and
the third processing unit 430 that performs the name resolution.

The DNS server 400 communicates with the router 300 by the third communication unit 410 and acquire the private IP address and global IP address from the router 300.

As shown in FIG. 1, the private IP address is used for the communication between the router 300 and the DNS server 400 because it is a closed network.

The global IP address is used for communicating outside of the closed network.

The DNS server 400 performs the name resolution by the third processing unit 430. “Name resolution” is to convert a domain name into an IP address (or from an IP address to a domain name).

In short, the DNS server 400 converts a global IP address into a domain name.

The query information is acquired by the DNS server 400. A “Query” is an inquiry for the data base control system (process request).

For example, the keyword the user types in the search window for a search site is a search query. The query information is stored in the third communication unit 420.

The keyword typed to the address field, such as https://www . . . is also a search query.

The DNS server 400 enables conversion of a global IP address into a domain name (name resolution). Therefore, the second terminal 800 user acquires the information such as which website was accessed or what was searched from the global IP address.

The second terminal 800 user sees the link (association) between the private IP address and the global IP address, therefore sees the outgoing information of the first terminal 200 and the domain name.

In short, the second terminal 800 user acquires the information of the communication destination such as which website was accessed by the first terminal 200.

### (Storage Server 500)

The storage server 500 includes,
the fourth communication unit 510 that it to communicate with the router 300 and the DNS server 400, and
the fourth memory unit 520 that stores the data.

The storage server 500 stores the NAT data and DNS data.

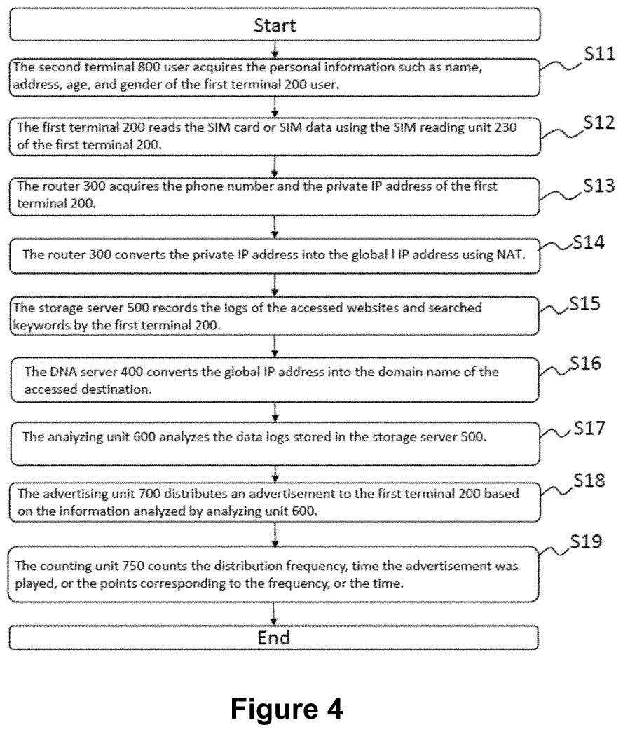

In this embodiment, as shown in FIG. 4, the storage server 500 stores the data that the NAT data and DNS data are combined.

In short, the storage server 500 stores the NAT logs in the router 300 and the name resolution logs (DNS logs) in the DNS server 400.

“Logs” are the records of the histories and information of the usage status and data communication.

In short, the storage server 500 stores the dates that the operations and data transmission/reception were conducted and the details of these activities.

The storage server 500 also stores the owner's data (customer data) of the first terminal 200. The storage server 500 may be the same server with the DNS server 400.

### (Analyzing Unit 600)

The analyzing unit 600 analyzes the NAT data and the DNS data stored in the storage server 500.

The analyzing unit 600 performs data mapping of the owner's data of the first terminal 200, the NAT data analyzed by the analyzing unit 600, and analyzed data acquired from the DNS data.

In short, the analyzing unit 600 links (associates) the owner's data of the first terminal 200 and the analyzed data.

Therefore, the second terminal 800 user acquires the phone number, private IP address and global IP address of the first terminal 200 by the NAT data and finds the global IP address and the domain name by the DNS data.

In short, the analyzing unit 600 links (associates) the first terminal 200 and the domain name of the access destination by performing data mapping of the NAT data, DNS data and customer data.

The analyzing unit 600 analyzes the website accessed by the first terminal 200 and the information of the search keyword (search query) searched on the search site such as Google (registered trademark).

### (Advertising Unit 700)

The advertising unit 700 notifies or displays the advertisement on the first terminal 200 based on the information analyzed by the analyzing unit 600.

The advertising unit 700 sends the advertisement that fits to the needs of the first terminal 200 user according to the owner's information, location, and access information of the first terminal 200.

The advertising unit 700 provides the advertisement that fits to the needs of the first terminal 200 user by selecting the advertisement based on not only the information based on the global IP address and the domain name, but also the information linked to the first terminal 200 and the owner's information.

In short, generally, a global IP address of the mobile phone such as a smartphone is open to the public and access time and location to the website may be known, but more detailed personal information is unknown.

With this embodiment, the second terminal 800 user links (associates) a private IP address and a global IP address by the NAT data and owns the personal information of the first terminal 200 user acquired at the time of contract. Therefore, the second terminal 800 user grasps the information such as where the first terminal 200 accessed the website from, the age and gender of the first terminal 200 user by data mapping of these information performed by the analyzing unit 600, and the advertising unit 700 sends the advertisement that accurately fits to the needs of the first terminal 200 user to the first terminal 200.

### (Advertisement by Time)

For example, the daily schedule of the first terminal 200 is known from the time the first terminal 200 used internet, and the advertising unit 700 sends the advertisement that fits to the daily schedule to the first terminal 200.

Specifically, when the first terminal 200 user started operating the mobile phone in the early morning such as at around 7:00 AM, the advertisement information of coffee may be displayed on the first terminal 200.

In short, when the first terminal 200 user accessed to the internet using the first terminal 200 between 7:00 to 9:00, the advertising unit 700 distributes, for example, the advertisement information of coffee.

Another example is that, when the first terminal 200 user started operating the mobile phone at around 18:00,(when started using internet), it is assumed that the user may finish working, the advertising unit 700 distributes, for example, the advertisement information of beer.

In short, when the first terminal 200 user accessed the internet using the first terminal 200 between 18:00 to 21:00, the advertising unit 700 displays the advertisement of beer on the displaying unit of the first terminal 200.

For example, when the first terminal 200 was operated (accessed to internet) between 24:00 to 26:00 even though the usual usage time is finished around 23:00 to 24:00, it may be assumed that the first terminal 200 user may have trouble sleeping.

Therefore, in this case, when the first terminal 200 uses the internet, the advertising unit 700 may display the comfortable pillow on the first terminal 200.

In short, when the first terminal 200 user access the internet using the first terminal 200 between 24:00 to 26:00, the advertisement of the comfortable pillow may be distributed.

Therefore, the advertising unit 700 displays the advertisement that fits to the lifestyle of the first terminal 200 user on the first terminal 200.

### (Advertisement by Genre)

The advertising unit 700 sends the advertisement categorized by genre to the first terminal 200.

Specifically, when the first terminal 200 user accessed the internet using the first terminal 200, the advertisement in the genre related to the application is sent.

For example, when the health meter application displayed on the first terminal 200 was opened, it is assumed that the first terminal 200 user is interested in weight loss.

Therefore, in this case, the advertising unit 700 displays the advertisement of weight loss on the displaying unit of the first terminal 200 when the application is opened.

In this case, the advertising unit 700 may send the advertisement of weight loss only when the health meter application is opened or whenever any application is opened.

Another example is that the advertising unit 700 sends the advertisement of the same genre with the searched or purchased products on the internet market application displayed on the first terminal 200.

Specifically, when the first terminal 200 user opens Amazon (registered trademark) application displayed on the first terminal 200 and searched a gaming chair, the advertising unit 700 sends the advertisement related to a gaming chair to the first terminal 200 assuming that the first terminal 200 user is interested in a gaming chair. In this way, the advertisement that fits to the first terminal 200 user is provided by knowing the personal information of the first terminal 200 user.

### (Advertisement by Area)

The analyzing unit 600 analyzes the location of the first terminal 200 and the data of the place it is used frequently from the information of the location where the first terminal 200 accessed the internet from.

The location information of the first terminal 200 is also analyzed by the GPS and logs of the first terminal 200.

The advertising unit 700 sends the advertisement of the vicinity of the first terminal 200 to the first terminal 200.

For example, when the first terminal 200 user opened the gourmet information application such as TABEROGU (registered trademark), or searched the restaurant nearby, the advertising unit 700 displays the gourmet information in the vicinity of the location of the first terminal 200.

The advertising unit 700 may periodically send the advertisement.

It is preferable for the advertising unit 700 to send an advertisement but it may be a video or in the other form such as a picture

The advertisement by area may not only be the advertisement based on the location of the first terminal 200 but it may be the advertisement of the information of the area based on the searched destination of the trip by the first terminal 200.

For example, when Okinawa was searched on the first terminal 200, the advertising unit 700 displays the advertisement about Okinawa information on the displaying unit of the first terminal 200.

When the “snow festival” is searched by the first terminal 200, the advertising unit 700 displays the advertisement regarding the “snow festival” on the displaying unit of the first terminal 200.

Therefore, in this embodiment, the advertising system 100 may be useful for contribution for local communities, and local revitalization.

The second terminal 800 communicates with the router 300, DNS server 400, storage server 500, analyzing unit 600 and advertising unit 700 and also control them.

The second terminal 800 may be the terminal acknowledged as a plane diagram showing the communication path from the phone number to the access destination domain as from the point A to point B.

### (Access Restriction)

The second terminal 800 user has the personal information of the first terminal 200 user and knows the private IP address of the first terminal 200 and the global IP address linked to the first terminal 200, therefore, for instance, if the age of the first terminal 200 user is under 18 years old, access restriction is available in order to prevent the person from accessing to the harmful website.

Specifically, many mobile phone carriers make a global IP address in gateway server open to public on the website and by checking the global IP address, it may be judged whether the access to the website was via a gateway server or not (more specifically, whether it is from a mobile phone or not).

For example, to restrict access from PC to the website for a mobile phone, the general setting is to allow access only from a mobile phone based on the value of HTTP_USER_AGENT.

However, the value of HTTP_USER_AGENT may easily be spoofed, this access restriction method is not perfect.

On the other hand, in the case that the access is only allowed when the global IP address of the access user matches the IP address of the mobile phone carrier gateway server, access restriction may be stricter by utilizing the global IP address information since the global IP address spoofing is far more difficult than HTTP_USER_AGENT spoofing.

In this embodiment, since the second terminal 800 user also knows the private IP address of the first terminal 200, access restriction is stricter.

From the above, the first terminal 200 user is protected from being involved in crimes and crime acts may be prevented from happening.

### (Counting Unit 750)

The counting unit 750 counts the duration of time the advertisement video distributed to the first terminal 200 is played, the frequency of the advertisement distribution, or the points corresponding to the time or frequency.

For example, the counting unit 750 counts the duration of the time the advertisement video is played or the points corresponding to the time when the video is played assuming the first terminal 200 user watched the video.

The counting unit 750 also counts the number of the advertisement distribution from the advertising unit 700 or the points corresponding to the number.

According to the time, number, or points the counting unit 750 counted, the communication fee of the first terminal 200 may be discounted.

The counting unit 750 may count the time or the points corresponding to the time as full length of the advertisement video even if the video is not fully played.

The counting unit 750 may also be set to count the time or the points when the advertisement video is fully played to the end.

### (Advertising Method)

FIG. 4 is the flow chart of the advertising method. The second terminal 800 user contracts with the first terminal 200 user and provides a SIM card or SIM data to the first terminal 200 user.

Specifically, the second terminal 800 user acquires the personal information such as name, address, age and gender of the first terminal 200 user (Personal information acquiring process, step S11).

The first terminal 200 user inserts the SIM card to the first terminal 200 or makes the terminal read the SIM data (Reading process).

Specifically, the first terminal 200 reads the SIM card or SIM data by the SIM reading unit 230 of the first terminal 200 (Reading process, step S12)

The router 300 acquires the phone number and the private IP address of the first terminal 200 (Private IP acquiring process, step S13).

The router 300 may decides the private IP address.

The router 300 converts a private IP address into a global IP address using NAT. (IP address conversion process, step S14).

The global IP address is used for the internet outside of the closed network.

The storage server 500 records the logs of the accessed websites and searched keywords by the first terminal 200 (Storing process, step S15).

The DNS server 400 converts the global IP address into the domain name of the access destination. (Domain conversion process, step S16).

The phone number of the first terminal and the domain name of the access destination are linked and the second terminal 800 user finds the information including which website was accessed and which word was searched by the first terminal 200.

Specifically, the analyzing unit 600 analyzes the data logs stored in the storage server 500, and the information such as which website was accessed and which word is searched by the first terminal 200 (Analyzing process, step S17).

The advertising unit 700 distributes an advertisement to the first terminal 200 based on the information analyzed by the analyzing unit 600 (Advertising process, step S18).

The counting unit 750 counts the frequency that the advertisement was distributed to the first terminal 200 or the points corresponding to the frequency (Counting process, step S19).

When the advertising unit 700 distributes an advertisement video to the first terminal 200, the counting unit 750 counts the time the video was played or the points corresponding to the time (Counting process, step S19).

This invention may be carried out in the form that was added various improvements, revisions, or changes in a range not departing from its original purpose.

### EXPLANATION OF SYMBOLS

100: Advertising system

200: The first terminal

300: Router

310: The second communication unit

320: The second memory unit

330: The second processing unit

400: DNS server

410: The third communication unit

420: The third memory unit

430: The third processing unit

500: Storage server

600: Analyzing unit

700: Advertising unit

750: Counting unit

800: The second terminal

1. An advertisement method using a server and a router, and distributing an advertisement to terminals including a smartphone and tablet by the server,
wherein the server comprises:
a communication unit that communicates with a terminal;
a memory unit to store data;
an analyzing unit to analyze the data; and
an advertising unit to distribute an advertisement to the terminal,
wherein the memory unit stores a phone number and a private IP address of the terminal,
the router has an IP address conversion process that converts the private IP address into a global IP address by NAT,
the server has a domain conversion process that converts the global IP address into a domain name,
the analyzing unit analyzes the domain name of an access destination corresponding to the phone number of the terminal stored in the memory unit, and
the advertising unit distributes the advertisement to the terminal based on the analysis of the analyzing unit.

2. The advertising method stated in claim 1,
wherein the analyzing unit analyzes a communication information of the terminal including the access destination of the terminal by performing data mapping of the information of the terminal and DNS information stored in the server.

3. The advertising method stated in claim 1, wherein the advertising unit distributes the advertisement to the terminal based on keywords searched by the terminal.

4. The advertisement method stated in claim 1, wherein the advertisement unit distributes the advertisement to the terminal based on a location of the terminal.

5. The advertising method stated in claim 1,
wherein the memory unit stores a personal information of a terminal user including at least one information selected from the group consisting of age, address, and gender, and
the advertising unit distributes the advertisement to the terminal based on the personal information.
